(19) United States
(12) Patent Application Publication
(10) Pub. No.: US 2010/0056660 A1
(43) Pub. Date: Mar. 4, 2010

(54) Decorative molded foams with good fire retardant properties

(75) Inventor: James W. Rosthauser, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 12/231,153

(22) Filed: Aug. 29, 2008

(51) Int. Cl. C08G 18/02

(52) U.S. Cl. 521/172; 521/155

(57) ABSTRACT

This invention relates to a fire-resistant, medium density polyurethane foam. The foam is made up of a) 50 to 90 parts by weight of water blown polyurethane and b) 10 to 50 parts by weight of a solid flame retardant that contains ammonium polyphosphate and zinc borate, and in which the resultant foam contains at least 5% by weight of zinc borate. The present invention also relates to a process for the preparation of these fire-resistant, medium density polyurethane foams.

### BACKGROUND OF THE INVENTION

This invention relates to decorative molded foams which exhibit good fire retardant properties and to a process for preparing these decorative molded foams.

Polyurethane foams are used for a wide variety of applications, such as thermal insulation, packaging, upholstery, carpet underlay, automobile dashboards, building materials, and structural material. An important factor to be considered in employing polyurethane or other polymeric foams is the ability of such foams to resist ignition, or once ignited, to be self-extinguishing after the ignition source is removed. This factor becomes even more important if the foam is to be used within a confined space or in outdoor applications in locations that are fire-prone. These decorative molding foams can even be used, for example, as roofing materials for fire-prone areas.

As those skilled in the art are aware, the most common method of decreasing the flammability of polyurethane foams is by incorporating a flame retarding agent, such as a halogen- or phosphorus-containing compound, into the foam formulation. Although such compounds provide some improvement in the flame retardation properties, relatively large quantities of these agents may have to be employed to obtain satisfactory results. In general, incorporating relatively high amounts of flame retardants into the foams reduces the overall physical property levels of the polyurethane foams.

For many years, the dominant blowing agents used to expand polyurethane foam had been the cholorfluorocarbons. These blowing agents were phased out after having been determined to pose a threat to stratospheric ozone. After the cholorfluorocarbons were phased out, the most common class of blowing agents became the hydrogenated chlorofluorocarbons. Although these are considered to be somewhat more environmentally friendly expansion agents, the hydrogenated chlorofluorocarbons still contain some chlorine. The chlorine atoms of hydrogenated chlorofluorocarbons are stable at altitudes under the stratosphere, and thus have a lower ozone-depleting potential (“ODP”). However, because of the hydrogenated chlorofluorocarbons still have a small ODP, they have also been mandated for eventual phase out. Water and/or carbon dioxide are rapidly becoming the blowing agents of choice for polyurethane foam manufacturers.

As known to those skilled in the art, polyurethane foams can be made using trimethylolpropane-based polyols (See e.g., U.S. Pat. Nos. 6,319,962, 4,690,954 and 4,407,981). Although there are some polyurethane foams available that pass the ASTM E-84 Tunnel Test “Standard Test Method for Surface Burning Characteristics of Building Materials” (ASTM International) with a Class I rating (U.S. Pat. Nos. 4,797,428 and 4,940,632), these foams use the alternative chlorofluorocarbon/hydrogenated chlorofluorocarbon blowing agents in combination with highly loaded polyester polyol blends and liquid flame retardants or have high flame retardant filler loadings, including phosphorus-based materials, in combination with trimethylolpropane-based polyols to produce the desired end result. These polyester-containing foams tend to reduce long term hydrolytic and “creep” stability and thus become a problem for applications outside of insulation-type foams.

U.S. Pat. No. 5,086,084 describes a foamed polymeric material suitable as a wood substitute, made of a continuous phase of polyurethane having solid polyvinyl chloride particles dispersed therein. The wood-like material of this patent contains about 100 parts of a foamable urethane, and 10 to 50 parts polyvinyl chloride (PVC) particles having a particle size below 200 μm. This material has a microcellular structure with cells on the order of 0.1 mm in average diameter or less. The walls are said to be made of a matrix of polyurethane reinforced with PVC particles. There is, however, makes no mention of the heat performance properties of this wood substitute.

Therefore, despite the abundance of disclosed processes to obtain flame retardant foams, polyurethane foam manufacturers remain interested in a foam that is solely water-, or carbon dioxide-blown; that satisfies the burning brand test ASTM E-108 with a Class A rating. A flame retardant combination that minimizes the amount of halogen-containing compounds would also be highly desirable from an environmental perspective.

Thus, the development of such flame retardant polyurethane foam would be very desirable. Because of environmental concerns, it would be also be desirable for such a foam use non chlorofluorocarbon/hydrogenated chlorofluorocarbon-containing blowing agents, such as water and/or carbon dioxide.

The paper titled “Ammonium Polyphosphate-Aluminum Trihydroxide Antagonism in Fire Retarded Butadiene-Styrene Block Copolymer” by A. Castrovinci et al in European Polymer Journal, (2005), 41(9), 2023-2033, discusses the effect of aluminum trihydroxide (ATH) on the surface protection from fire provided by ammonium polyphosphate (APP) to a styrene butadiene rubber (SBR). It was necessary to add a significantly higher amount of ATH than APP to achieve comparable results, i.e. 60 wt. % of ATH vs. 10-12 wt. % of APP. In addition, the substitution of 1 wt. % of ATH for APP in an SBR containing 12 wt. % of APP showed an antagonistic effect. This is explained by Castovinci et al by the interaction between SBR, APP and ATH in which aluminum phosphates form on heating APP in SBR, and these aluminum phosphates negatively affect the surface protection that the APP provides to the SBR.

The interaction between two fire retardants was studied in “Structural and Thermal Interpretation of the Synergy and Interactions Between the Fire Retardants Magnesium Hydroxide and Zinc Borate” by A. Genovese et al, Polymer Degradation and Stability, (2007), 92(1), 2-13. The fire performance of a polyolefin with a magnesium hydroxide fire retardant reduces the heat release rate through absorption of heat during conversion to magnesium oxide. Zinc borates which undergo dehydration with increasing temperatures also increased fire performance of a polyolefin. Various structural changes were seen in the zinc borates. Endothermic transitions occurred in zinc borates, and 2ZnO.3B₂O₃.3H₂O underwent an exothermic crystalline transition at a high temperature. In addition, magnesium orthoborate (3MgO.B₂O₃), a new crystalline phase, and some zinc oxide (ZnO), formed on reaction of magnesium oxide with zinc borate (2ZnO.3B₂O₃.3H₂O) at temperatures greater than 500° C. Thus, it appears that there is a synergy that results from the combination of magnesium hydroxide and zinc borates as flame retardants for polyolefins.

Flame resistant, thermoplastic polyurethane elastomers and processes for their preparation are disclosed in U.S. Pat. No. 4,748,195. The flame retardant package in these TPUs is (a) a compound selected from the group consisting of antimony trioxide, zinc borate and mixtures thereof, (b) a chlorinated polyethylene, and (c) a brominated aromatic compound selected from the group consisting of polytetrabromo-bis(phenol)-A-glycidyl ether, polytribromostyrene and polytetrabromobis (phenol)-A-carbonate. Polyurethane foams are not mentioned in this reference.

EP Application 0,512,629 (Akzo 1992, which is believed to correspond to U.S. Application Serial No. 1991696673) discloses the usefulness of zinc borate in combination with encapsulated ammonium polyphosphate in thermoplastic urethanes. It also discloses that the solid elastomer compositions can achieve V0 rating in a UL94 vertical burn test. The flame retardant combination must contain, in addition to zinc borate and a “carbonific” (polyhdric char-forming) compound such as pentaerythritol, a large excess of ammonium polyphosphate comprising from 30 to 50% of the filled polyurethane. These materials have densities of 65 to 100 pcf making them less attractive as construction materials from a practical and economical perspective.

Zinc borates and their use as fire-retardants in halogen-containing and halogen-free polymers are described in “Recent Advances in the use of Borates as Fire Retardants in the journal “Recent Advances Flame Retardant Polymeric Materials”, (RAFMFH), 1995, Vol. 6, pp. 239-247. Advantages of zinc borates include its ability to act as a smoke suppressant, flame retardant, afterglow suppressant, char promoter, anti-arcing agent, and improves oil resistance, and inhibits plate out in polymers containing siloxanes.

In polyurethane foams, there is a need for improved flame retardant foam systems that are free of halogenated flame retardants, and particularly for those polyurethane foams that are blown with water and/or carbon dioxide, which are environmentally friendly blowing agents.

Advantages of the present invention include
1) foams have medium density (10-30 pounds per cubic foot (pcf)) making them suitable for construction materials;
2) foams are highly flame resistant allowing them to be used in fire-prone areas;
3) flame retardants are effective in these polyurethane foams without comprising halogen-containing compounds and are thus more environmentally acceptable; and
4) foams contain relatively low amounts of flame retardant such that they remain flexible enough for demanding applications.

### SUMMARY OF THE INVENTION

This invention relates to fire-resistant, molded, medium density polyurethane foams and to a process for preparing these polyurethane foams.

These fire-resistant, molded, medium density (i.e. 10 to 30 pcf) polyurethane foams comprise:
a) 50 to 90, and preferably more than 75 to 85, parts by weight of a polyurethane foam forming reactive mixture,
b) 10 to 50, and preferably 15 to less than 25, parts by weight of solid flame retardant comprising
   (i) ammonium polyphosphate,
   (ii) zinc borate,
   and, optionally,
   (iii) one or more metal oxides or hydrates thereof, in which the weight ratio of ammonium polyphosphate to zinc borate ranges from 3:1 to 1:3;
      wherein the resultant polyurethane foam comprises at least 5% by weight, based on 100% by weight of the foam, of zinc borate.

The process of preparing these fire-resistant, molded, medium density polyurethane foams comprises:
(1) introducing a polyurethane foam forming composition into an open mold,
(2) closing the mold,
(3) allowing the composition to react, and
(4) removing the molded polyurethane foam from the mold,
   wherein the polyurethane foam forming composition comprises:
   a) 50 to 90, preferably more than 75 to 85, parts by weight of a polyurethane foam forming reactive mixture,
   b) 10 to 50, preferably 15 to less than 25, parts by weight of solid flame retardant comprising
      (i) ammonium polyphosphate,
      (ii) zinc borate,
      and, optionally,
      (iii) one or more metal oxides or hydrates thereof, in which the weight ratio of ammonium polyphosphate to zinc borate ranges from 3:1 to 1:3;
   and the resultant polyurethane foam comprises at least 5% by weight, based on 100% by weight of the foam, of zinc borate.

### DETAILED DESCRIPTION OF THE INVENTION

As used herein, unless otherwise expressly specified, all of the numerical ranges, amounts, values and percentages such as those for amounts of materials, times and temperatures of reaction, ratios of amounts, values for molecular weight, and others in the following portion of the specification may be read as if prefaced by the word “about” even though the term “about” may not expressly appear with the value, amount or range.

Suitable polyurethane foam forming reactive mixtures for the invention herein are water blown polyurethane foam forming reactive mixtures in which the amount of water present is sufficient to result in a medium density foam, i.e. a density of about 10 to about 30 pcf. Typically, this is about 0.1 to about 1.0 (and preferably about 0.2 to about 0.7) parts by weight of water, based on 100 parts by weight of the polyurethane foam system. The amount of water is the total amount in the polyurethane foam-forming reactive mixture and includes water that is often adsorbed onto the hygroscopic surfaces of the flame retardant solids.

The polyurethane foam forming reactive mixtures herein include those known in the art. These are typically the reaction product of (1) one or more polymethylene poly(phenyl isocyanate), an isocyanate group containing prepolymer based on a polymethylene poly(phenyl isocyanate), or mixtures thereof, with (2) one or more isocyanate-reactive components.

In accordance with the present invention, component (1) comprises a polymethylene poly(phenyl isocyanate), an isocyanate group containing prepolymer based on a polymethylene poly(phenyl isocyanate), or mixtures thereof, having an NCO group content of 25 to 33% by weight. It is more preferred that the polyisocyanates for the presently claimed invention are compositions having a functionality of from about 2.1 to about 3.8, and an NCO group content of about 25% to about 33%, a viscosity of less than about 1000 mPa·s at 25° C.

The polyisocyanates will typically have an NCO functionality of at least 2.1, preferably at least 2.3 and more preferably at least 2.5. These polyisocyanates also typically have an NCO functionality of less than or equal to 3.8, preferably less than or equal to 3.5 and more preferably less than or equal to 3.2. The polyisocyanates of the invention may have an NCO functionality ranging between any combination of these upper and lower values, inclusive, e.g. from 2.1 to 3.8 preferably from 2.3 to 3.5 and more preferably from 2.5 to 3.2.

The polyisocyanates of the present invention typically have an NCO group content of at least 25% by weight, preferably at least 27.5% by weight and most preferably at least 29% by weight. These polyisocyanates also typically have an NCO group content of less than or equal to 33% by weight, preferably less than or equal to 32% by weight and more preferably less than or equal to 31 % by weight. Suitable polyisocyanates may have an NCO group content ranging between any combination of these upper and lower values, inclusive, e.g., from 25% to 33% by weight, preferably from 27.5% to 32% by weight, and more preferably from 29% to 31 % by weight.

It is most preferred that the polyisocyanates have an NCO group content of from 27.5% to 32% and a functionality of from 2.3 to 3.5. Suitable polyisocyanates satisfying this NCO group content and functionality include, for example, polymethylene poly(phenyl isocyanates) and prepolymers thereof having the required NCO group content and functionality.

Polymeric MDI as used herein, refers to polymethylene poly(phenyl isocyanate) which in addition to monomeric diisocyanate (i.e., two-ring compounds) contains three-ring and higher ring containing products.

A particularly preferred polyisocyanate comprises a polymethylene poly(phenylisocyanate) having an NCO content of about 31.5%, a functionality of about 2.8, a viscosity of about 200 mPa·s at 25° C.

Suitable prepolymers to be used as component (1) herein include those prepared by reacting an excess of a polymethylene poly(phenyl isocyanate) with an isocyanate-reactive component to form an NCO terminated prepolymer. Such isocyanate-terminated prepolymers are disclosed in U.S. Pat. No. 5,962,541, the disclosure of which is hereby incorporated by reference. In the practice of the present invention, the polymeric diphenylmethane diisocyanate is reacted with a polyol, preferably a polyester polyol or a polyol blend having a functionality of from about 1.8 to about 4, and a number average molecular weight (as determined by end-group analysis) of from about 400 to about 2000. These quasi-prepolymers should have functionalities and NCO group contents within the ranges set forth above.

Suitable polyols for preparing the isocyanate-terminated prepolymers herein typically have a functionality of at least about 1.8, and more preferably at least about 1.9. These polyols also typically have functionalities of less than or equal to about 4, more preferably less than or equal to about 2.4, and more preferably less than or equal to about 2.2, In addition, the polyol may have a functionality ranging between any combination of these upper and lower values, inclusive, e.g. from 1.8 to 4, preferably from 1.8 to 2.4, and more preferably from 1.9 to 2.2.

The polyols used to prepare the isocyanate-terminated prepolymers herein also typically have a number average molecular weight of at least about 400, and more preferably at least about 450. These polyols also typically have a number average molecular weight of less than or equal to 2000, preferably less than or equal to 800 and most preferably less than or equal to 500. These polyols may also have number average molecular weights ranging between any combination of these upper and lower values, inclusive, e.g. from 400 to 2000, preferably from 400 to 800, and more preferably from 450 to 500.

A particularly preferred polyisocyanate prepolymer comprises a reaction product of polymethylene poly(phenylisocyanate) and a 450 molecular weight polyester having an NCO content of about 30.5%, a functionality of about 2.8, and a viscosity of about 350 mPa·s at 25° C.

Suitable isocyanate-reactive components for forming the polyurethane foam include, for example, one or more higher molecular weight components and one or more lower molecular weight components. Examples of suitable isocyanate-reactive components that have higher molecular weights include compounds such as polyether polyols, polyester polyols, polycarbonate diols, polyhydric polythioethers, polyacetals, aliphatic thiols, solids containing polyols including those selected from the group consisting of graft polyols, polyisocyanate polyaddition polyols, polymer polyols, PHD polyols and mixtures thereof, etc. Lower molecular weight compounds include lower molecular weight polyether polyols and other diols and triols, which may also be referred to as chain extenders and/or crosslinkers.

Preferred starting polyol components suitable for use in the polyol blends or mixtures according to the present invention include polyesters containing at least two hydroxyl groups, as a rule having a molecular weight of from 300 to 10,000, in particular polyesters containing from 2 to 8 hydroxyl groups, preferably those having a molecular weight of from 350 to 3000, more preferably from 350 to 2000. These polyesters are used in amounts greater than 30%, preferably greater than 45%, most preferably greater than 55% of the polyol portion of the polyurethane foams.

These polyesters containing hydroxyl groups can include for example, reaction products of polyhydric, preferably dihydric and optionally trihydric, alcohols with phthalic acids and other polybasic, preferably dibasic, carboxylic acids. Instead of using the free phthalic acids or polycarboxylic acids, the corresponding acid anhydrides or corresponding acid esters of lower alcohols or mixtures thereof may be used for preparing the polyesters. Orthophthalic acids, isophthalic acids and/or terephthalic acids may be used as the phthalic acid. Other polybasic-carboxylic acids may be aliphatic, cycloaliphatic, aromatic and/or heterocyclic and may be substituted, for example, with halogen atoms and/or may be unsaturated. The following are mentioned as examples; succinic acid, adipic acid, suberic acid, azelaic acid, sebacic acid, trimellitic acid, tetrahydrophthalic acid anhydride, hexahydrophthalic acid anhydride, endomethylene tetrahydro phthalic acid anhydride, glutaric acid anhydride, maleic acid, maleic acid anhydride, fumaric acid, dimeric and trimeric fatty acids, such as oleic acid, optionally mixed with monomeric fatty acids. Suitable polyhydric alcohols include, for example, ethylene glycol, propylene glycol-(1,2) and -(1,3), diol-(1,8), neopentyl glycol, cyclohexane dimethanol(1,4-bis-hydroxymethylcyclohexane), 2-methyl-1,3-propane diol, glycerol, trimethylolpropane, hexanetriol-(1,2,6)butane triol-(1,2,4), trimethylolethane, pentaerythritol, quinitol, mannitol and sorbitol, methylglycoside, also diethylene glycol, triethylene glycol, tetrathylene glycol, polyethylene glycols, dibutylene glycol, and polybutylene glycols. The polyesters may also contain carboxyl end groups. Polyesters of lactones, such as ε-caprolactone, or hydroxycarboxylic acids, such as δ-hydroxycaproic acid, may also be used.

Preferred polyester polyols for the use in this invention are the polyesters of lactones or the reaction products of i) adipic acid and ii) low molecular weight aliphatic diol compounds. Molecular weights of these preferred polyesters are from 500 to 3000, preferably from 1000 to 2000. Particularly preferred polyester polyols for use in the invention comprise the reaction products of (i) phthalic acid compounds and (ii) low molecular weight aliphatic diol compounds. Molecular weights of these particularly preferred polyesters are from 350 to 700, preferably 350 to 600. Such polyester polyols are described in U.S. Pat. Nos. 4,644,047 and 4,644,048, the disclosures of which are hereby incorporated by reference.

According to the present invention, polyethers containing at least one, generally from 2 to 8, preferably 3 to 6, hydroxyl groups and having a molecular weight of from 100 to 10,000 of known type may be used in the polyol blend. These are prepared, for example, by the polymerization of epoxides, such as ethylene oxide, propylene oxide, butylene oxide, tetrahydrofuran, styrene oxide, or epichlorohydrin, either on its own for example in the presence of BF₃, or by chemical addition of these epoxides, optionally as mixtures or successively, to starting components having reactive hydrogen atoms, such as alcohols or amines, for example water, ethylene glycol, propylene glycol-(1,3) or -(1,2), trimethylol propane, 4,4-dihydroxy diphenylpropane aniline, ammonia ethanolamine or ethylene diamine. Sucrose polyethers which have been described, for example in German Auslgeschrift Nos. 1,176,358 and 1,064,938 may also be used and are preferred according to the present invention. It is preferred to use polyethers with OH numbers above 200.

Typically, these polyether polyols have an OH functionality of at least 2, and preferably at least 3. These polyether polyols also typically have an OH functionality of less than or equal to 8.0, and preferably less than or equal to 6.0. The polyether polyols of the invention may have an OH functionality ranging between any combination of these upper and lower values, inclusive, e.g. from 2.0 to 8.0, and preferably from 3.0 to 6.0.

The polyether polyols of the present invention typically have an OH number of at least 250, preferably at least 300 and most preferably at least 350. These polyether polyols also typically have an OH number of less than or equal to 750, preferably less than or equal to 650 and more preferably less than or equal to 550. The polyether polyols may have an OH number ranging between any combination of these upper and lower values, inclusive, e.g., from 250 to 750, preferably from 300 to 650, and more preferably from 350 to 550.

Although less preferred, it is possible to incorporate polyethers with OH numbers between 14 and 56 to increase flexibility and impact resistance of the resulting foams. In those occasions when this is necessary, the amount of high molecular weight polyethers added should be less than 25%, preferably less than 15%, and most preferably less than 10%, by weight of the polyol portion of the polyurethane foams.

Among the corresponding polythioethers which may also be used are the condensation products obtained from thiodiglycol on its own and/or with other glycols, dicarboxylic acids, formaldehyde, aminocarboxylic acids or aminoalcohols should be particularly mentioned. The products obtained are polythio mixed ethers, polythio ether esters or polythio ether ester amides, depending on the co-components.

Polyhydroxyl compounds already containing urethane or urea groups and modified or unmodified natural polyols, such as castor oil, carbohydrates or starch may also be used. Addition products of alkylene oxides and phenyl/formaldehyde resins or of alkylene oxides and urea/formaldehyde resins are also suitable according to the present invention.

Representatives of these compounds which may be used according to the present invention have been described, for example, in High Polymers, Volume XVI, “Polyurethanes, Chemistry and Technology”, by Saunders and Frisch, Interscience Publishers, New York; London, Volume I, 1962, pages 32-42 and pages 44 to 54 and Volume II, 1964, pages 5 and 6 and 198-199, and in Kunststoff-Handbuch, Volume VII, Vieweg-Hochtlen, Carl-Hanser-Verlag, Munich, 1966, for example, on pages 45 to 71.

With regard to the lower molecular weight component of the isocyanate-reactive component, both chain extenders and crosslinkers are suitable. These low molecular weight components typically have hydroxyl functionalities ranging from 1.5 to 4.0, molecular weights ranging from 62 to 450 and OH numbers ranging from 250 to 1900.

Such low molecular weight components typically have hydroxyl functionalities of at least 1.5 and preferably at least 2.0. These low molecular weight components also typically have a hydroxyl functionality of less than or equal to 4.0, and preferably less than or equal to 3.0. The polyether polyols of the invention may have an OH functionality ranging between any combination of these upper and lower values, inclusive, e.g. from 1.5 to 4.0, and preferably from 2.0 to 3.0.

The low molecular weight components typically have molecular weights of at least 62 and preferably at least 100. These components also typically have molecular weights of less than or equal to 450, and preferably less than or equal to 300. The chain extenders and/or crosslinkers of the invention may have a molecular weight ranging between any combination of these upper and lower values, inclusive, e.g. from 62 to 450, and preferably from 100 to 300.

These low molecular weight components typically have hydroxyl numbers of at least 250 and preferably at least 350. These components also typically have hydroxyl numbers of less than or equal to 1900, and preferably less than or equal to 1100. The chain extenders and/or crosslinkers of the invention may have hydroxyl numbers ranging between any combination of these upper and lower values, inclusive, e.g. from 250 to 1900, and preferably from 350 to 1100.

Some examples of suitable chain extenders to be used herein include ethylene glycol, 1,2- and 1,3-propanediol, 1,3-, 1,4- and 2,3-butanediol, 1,6-hexanediol, 1,8-octanediol, 1,10-decanediol, neopentyl glycol, 1,3- and 1,4-bis(hydroxymethyl)cyclohexane, 2-methyl-1,3-propanediol, diethylene glycol, triethylene glycol, tetraethylene glycol, polyethylene glycols, dipropylene glycol, tripropylene glycol, polypropylene glycols, dibutylene glycol, tributylene glycol, polybutylene glycols, N-methyl-diethanolamine, cyclohexane-dimethanol, 2-methyl-1,3-propanediol, and 2,2,4-trimethylpentane-1,3-diol. Other suitable chain extenders are amine-started polyethers such as the alkoxylation products of ethylenediamine, toluenediamine, monoethanolamine, diethanolamine, and triethanolamine, etc.

Also suitable are mixtures of the above chain extenders with higher functional compounds such as glycerol and/or trimethylolpropane, provided that the overall functionality of the mixture falls with the required range for chain extenders described herein. Any of the previously mentioned diols that are disclosed herein as being suitable for preparing polyesters are also suitable as chain extenders in accordance with the present invention. Preferred chain extenders are diethylene glycol and mixtures of dipropylene with tripropylene glycol.

Suitable crosslinking agents to be used herein include compounds such as trimethylolpropane, pentaerythritol, glycerine and the lower molecular weight polyethers formed from glycerine and propylene oxide, which are preferred.

One suitable isocyanate-reactive component for the polyurethane foam forming reactive mixtures herein comprises:
(a) 30 to 70 parts by weight of at least one polyester polyol having a functionality of from 1.5 to 3.0 and an OH number of from 25 to 250, and which comprises the reaction product of
   (i) one or more aliphatic dicarboxylic acids, with
   (ii) one or more diols or triols;
(b) 20 to 40 parts by weight of at least one highly branched polyether polyol having a functionality of 3.0 to 8.0 and an OH number of 250 to 750 (and is preferably prepared by alkoxylating sucrose or a mixture of sucrose and one or more other suitable starter compounds);
and
(c) 10 to 30 parts by weight of at least one chain extender having a hydroxyl functionality of from 2.0 to 2.9 and an OH number of from 400 to 1900,
   with the sum of the parts by weight of (a), (b) and (c) totaling 100 parts by weight of (2) the isocyanate-reactive component.

When using this particular isocyanate-reactive component to form a water blown polyurethane composition in the present invention, it is preferably reacted with 80 to 160 parts by weight of polymethylene poly(phenyl isocyanate), an isocyanate group containing prepolymer based on a polymethylene poly(phenyl isocyanate), or mixtures thereof having an NCO group content of from 25 to 33% by weight; water in a sufficient amount to result in a medium density (i.e. 10 to 30 pcf) polyurethane foam, and solid flame retardant as described herein.

A preferred isocyanate-reactive component to be used in accordance with the present invention comprises
(a) from 30 to 70 (preferably 45 to 65) parts by weight of at least one polyester polyol having a functionality of 2.0 to 3.0 and an OH number of 160 to 320, and that is the reaction product of one or more polyhydric alcohols with one or more phthalic acids or other polybasic (preferably dibasic) carboxylic acids, corresponding acid anhydrides or corresponding acid esters;
(b) 0 to 25 (preferably 0 to 15) parts by weight of a polyether polyol having a functionality of from about 1.5 to about 3 and an OH number of from about 14 to about 56;
(c) 0 to 30 parts by weight of at least one highly branched polyether polyol having a functionality of 3.0 to 8.0 and an OH number of 250 to 750 (and is preferably prepared by alkoxylating sucrose or a mixture of sucrose and one or more other suitable starter compounds);
and
(d) from 0 to 30 (preferably 10 to 25) parts by weight of one or more chain extenders and/or one or more crosslinking agents,
   with the sum of the parts by weight of (a), (b), (c) and (d) totaling 100 parts by weight of (2) the isocyanate-reactive component.

In this preferred isocyanate-reactive component, the polyester polyol, component (a), preferably have a functionality of 2.0 to 3.0 and preferably has an OH number of 160 to 320. This polyester polyol component is preferably the reaction product of phthalic acid anhydride and diethylene glycol.

The preferred polyether polyols to be used as component (b) in the preferred isocyanate-reactive component, have a functionality of 1.8 to 3.5 and have an OH number of 14 to 56. These polyether polyols are preferably the reaction product of glycerine and a mixture of ethylene and propylene oxide.

The preferred polyether polyols to be used as component (c) in the preferred isocyanate-reactive component, have a functionality of 4 to 6 and have an OH number of 250 to 400. These polyether polyols are preferably the reaction product of a mixture of sucrose and water and/or propylene glycol and propylene oxide.

Preferred chain extenders and/or crosslinkers for component (d) of the above isocyanate-reactive component include diethylene glycol, tripropylene glycol, and gylcerine adducts with propylene oxide These preferably have functionalities of 2.0 to 3.0 and OH numbers of 550 to 1100.

The solid flame retardant component b) comprises (i) ammonium polyphosphate, (ii) zinc borate, and optionally, (iii) the one or more metal oxides or hydrates thereof. The metal oxides or hydrates thereof include, but are not limited to, alumina trihydrate, magnesium compounds such as, for example, magnesium hydroxide, calcium hydroxide, and the various antimony oxides. Suitable antimony oxides such as, for example, antimony pentaoxide and antimony trioxide.

In accordance with the present invention, the weight ratio of ammonium polyphosphate to zinc borate ranges from 3.0:1.0 to 1.0:3.0, preferably 2.0:1.0 to 1.0:2.0. In addition, the zinc borate is present in an amount such that the resultant polyurethane foam contains at least 5%, preferably at least 6% by weight of zinc borate.

When the metal oxides and hydrates thereof, are optionally also present as part of the solid flame retardant component, the weight ratios of zinc borate to these metal oxides and hydrates thereof, range from 1.0:3.0 to 3.0:1.0. In addition, the zinc borate is present in an amount such that the resultant polyurethane foam contains at least 5%, preferably at least 6% by weight of zinc borate, with the amount of ammonium polyphosphate present as defined above.

In accordance with the present invention, the solid flame retardants are typically used herein in amounts of from 10% to less than 50%, preferably 15 to less than 25% by weight, based on 100% by weight of the flame retardant-containing polyurethane foam.

Ammonium polyphosphate is known and described as, for example, as a flame retardant. Ammonium polyphosphate (APP) is an inorganic salt of polyphosphoric acid and ammonia. The chemical formula of APP is [NH₄PO₃]ₙ, and corresponds to the general structure:

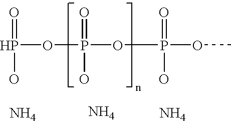

APP is a stable, non-volatile compound.

Suitable zinc borates to be used as component (ii) of the solid flame retardant include those corresponding to the general chemical formulas such as, for example, 2ZnO.3B₂O₃.5H₂O, 2ZnO.3B₂O₃.3.5H₂O, 2ZnO.3B₂O₃, 4ZnO.B₂O₃.H₂O, etc. Such zinc borates are commercially available from Rio Tinto Borax under the tradename Firebrake®. It is preferred that the flame retardant comprise zinc borate in a sufficient quantity such that the resultant polyurethane foam contains at least 5%, preferably from 6 to 15% by weight zinc borate.

In addition, the solid flame retardant component can optionally contain metal oxides, preferably alumina trihydrate.

In accordance with the present invention, the solid retardant contains (i) ammonium polyphosphate and (ii) zinc borate in a weight ratio of from 3.0:1.0 to 1.0:3.0, preferably from 2.0:1.0 to 1.0:2.0. In addition, in this embodiment the zinc borate is present in a sufficient quantity such that the resultant polyurethane foam contains at least 5% by weight of zinc borate.

When the solid flame retardant additionally comprises (iii) one or more metal oxides or hydrates thereof, this component is typically present in an amount such that the weight ratio of zinc borate to metal oxide or hydrate ranges from 3.0:1.0 to 1.0:3.0, and preferably from 2.0:1.0 to 1.0:2.0. The resultant polyurethane foams will also contain at least 5%, and preferably at least 6%, by weight of zinc borate. The ammonium polyphosphate is present in a quantity as previously described.

Alumina trihydrate is a preferred compound to be used as component (iii) of the solid flame retardant component. When alumina trihydrate is present as part of the solid flame retardant, it is preferably present in an amount such that the weight ratio of zinc borate to alumina trihydrate ranges from 3.0:1.0 to 1.0:3.0, and more preferably from 2.0:1.0 to 1.0:2.0. As previously discussed, the polyurethane foams of the present invention contains at least 5%, preferably at least 6%, by weight of zinc borate. Also, the quantity of ammonium polyphosphate is as defined above.

In addition, the solid flame retardant may optionally contain other solid flame retardants such as, for example, various cyclic phosphate and phosphonate esters, and reactive oligomeric organophosphates having functionalities greater than 1; melamine; urea; solid halogen-containing compounds such as brominated diphenyl ether as well as other brominated aromatic and aliphatic compounds, etc. It is preferred that any solid flame retardant added to the compositions herein are free of halogen atoms.

In an optional embodiment, the present invention may additionally comprise liquid flame retardants. The liquid flame retardants useful in the present invention may or may not contain halogen atoms. Liquid flame retardants known to those skilled in the art can be and most often are used to reduce viscosity in systems that use solid flame retardants. Although they reduce viscosity of the polyol portion to ease handling and processing of the polyurethane, they do not improve but rather also decrease the impact resistance of the resulting polyurethanes.

The flame retardant materials useful herein are also known in the art, and are commercially available. Useful liquid flame retardants include but are not limited to PHT-4 DIOL, available from Chemtura Corporation (or the equivalent Ethyl Corporation product RB-79), tris(chloropropyl)phosphate (Fyrol® PCF, available from Supresta Chemical), tris(chloroethyl)phosphate (Fyrol® CEF, available from Supresta Chemical), tris(1,3-dichloro-1-propyl)phosphate (Fyrol® 38, available from Supresta Chemical), tris(2,3-dichloro-1-propyl)phosphate. (Fyrol® FR-2, available from Supresta Chemical), triethyl phosphate (Fyrol® TEP available from Supresta Chemical), Antiblaze® 80, available from Albemarle, Antiblaze® 500, available from Albemarle, Ixol® B-251 and Ixol® 350, both available from Solvay-fluor, and dimethylmethyl phosphonate.

Other potential additives and auxiliary agents to be included in the polyurethane foam compositions herein include, for example, catalysts, surface-active additives such as emulsifiers and foam stabilizers, as well as, for example, known internal mold release agents, pigments, cell regulators, plasticizers, dyes, fillers and reinforcing agents such as glass in the form of fibers or flakes or carbon fibers. Polyvinyl chloride is incorporated as a filler.

Polyvinyl chloride is produced by polymerizing vinyl chloride by suspension, emulsion, or solution methods. It is often copolymerized with up to 50% other compatible monomers. PVC is processed by several methods including blow molding, extrusion, calendering, and coating. Plastisols comprising PVC resin particles dispersed in a liquid phase of a PVC plasticizer are used to produce coatings and molded products. PVC is resistant to weathering, moisture, most acids, fats, petroleum hydrocarbons and fungi. It is dimensionally stable, and has good dielectric properties. It is used for piping and conduits, containers, liners, and flooring.

Polyvinyl chloride resins useful herein are also well-known copolymers rich in vinyl chloride moieties. They may include up to about 50% by weight of a comonomer such as other vinyls or an acrylate. Alternatively, particles may be purchased commercially from manufacuturers such as Goodyear Tire and Rubber Corp., B.F. Goodrich, Westchem International, and Tenneco, Inc. Broadly, the invention may utilize mixtures of particles having diameters below about 200 microns. The molecular weight of the PVC may vary widely. PVC's having an average molecular weight within the range of about 80,000 to about 500,000 or higher may be used. Generally, the molecular weight (or inherent viscosity) is not an important factor.

Some examples of suitable catalysts, include tertiary amine catalysts and organometallic catalysts. Some examples of suitable organometallic catalysts include, for example organometallic compounds of tin, lead, iron, bismuth, mercury, etc. Also suitable are heat-activated amine salts as catalysts. These include both aliphatic and aromatic tertiary amines. It is preferred to use heat activated amine salts as catalysts.

Examples of emulsifiers and foam stabilizers include N-stearyl-N′,N′-bis-hydroxyethyl urea, oleyl polyoxyethylene amide, stearyl diethanol amide, isostearyl diethanol-amide, polyoxyethylene glycol monoleate, a pentaerythritol/adipic acid/-oleic acid ester, a hydroxy ethyl imidazole derivative of oleic acid, N-stearyl propylene diamine and the sodium salts of castor oil sulfonates or of fatty acids. Alkali metal or ammonium salts of sulfonic acid such as dodecyl benzene sulfonic acid or dinaphthyl methane sulfonic acid and also fatty acids may be used as surface-active additives.

Suitable foam stabilizers also include polyether siloxanes. The structure of these compounds is generally such that a copolymer of ethylene oxide and propylene oxide is attached to a polydimethyl siloxane radical. Such foam stabilizers are described in U.S. Pat. No. 2,764,565.

In accordance with the present invention, the various additives and auxiliary agents, as well as liquid flame retardants and/or polyvinyl chloride can be added to either the isocyanate-reactive component of the polyurethane foam forming reactive mixture, and/or, if these do not contain isocyanate-reactive groups, they can be added to the isocyanate-component of the polyurethane foam forming reactive mixture. Obviously, these additives, auxiliary agents, liquid flame retardants and/or polyvinyl chloride may also be added as separate components to the polyurethane foam forming reactive mixture.

The polyurethane foam compositions according to the present invention may be molded using conventional processing techniques at isocyanate indexes ranging from about 90 to 150 (preferably from 100 to 130). By the term “Isocyanate Index” (also commonly referred to as “NCO index”), is defined herein as the equivalents of isocyanate, divided by the total equivalents of isocyanate-reactive hydrogen containing materials, multiplied by 100.

An open mold is one that the reacting materials are not injected into, but rather poured into. The materials suitable for processing in open molds are normally characterized by having a slightly longer gel time and curing time than those used in the closed mold (typical RIM) processes.

In the process of preparing molded polyurethane foams from these foam forming compositions, one typically introduces a polyurethane foam forming composition into an open mold, closes the mold, allows the composition to react, and removes the molded polyurethane foam from the mold. Suitable information in terms of relevant conditions, suitable molds, demold times, end uses, etc. are known by those skilled in the art. It is preferred that the free rise density of foam is between 8 and 20 pcf (pounds per cubic foot) and that the molded density of the foams is between 12 and 24 pcf.

It is also possible, but less preferred, to use a traditional RIM process or other closed mold process to prepare molded parts from the polyurethane foam forming compositions described herein.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Fahrenheit and all parts and percentages are parts by weight and percentages by weight, respectively.

### EXAMPLES

The present invention is further illustrated, but is not to be limited, by the following examples. All quantities given in “parts” and “percents” are understood to be by weight, unless otherwise indicated.

The following components were used in the working examples:

| | |
|---|---|
| POLYOL A: | an aliphatic polyester polyol (i.e. a |
| | polyethylene/polybutylene adipate) having a |
| | functionality of two and a hydroxyl number of |
| | 55 |
| POLYOL B: | a sucrose-initiated polyether polyol having an |
| | OH number of about 470 mg KOH/g and a |
| | functionality of 5.2 |
| POLYOL C: | an aromatic polyester polyol having a |
| | functionality of 2 and a hydroxyl number of 190, |
| | commercially available as Stepanpol ® PS- |
| | 1922 from Stepan |
| POLYOL D: | diethylene glycol |
| SURFACTANT A: | a polyalkylene oxide methyl siloxane |
| | copolymer, commercially available from |
| | Momentive Performance Materials of Albany, |
| | NY as NIAX ® L 1000 |
| SURFACTANT B: | a polyalkylene oxide methyl siloxane copolymer |
| | commercially available from Air Products and |
| | Chemicals of Allentown, PA as Dabco ® DC- |
| | 193 |
| CATALYST A: | an acid blocked amine blowing catalyst, |
| | commercially available from Momentive |
| | Performance Materials of Albany, NY as Niax ® |
| | A-507 |
| CATALYST B: | an acid blocked amine gelling catalyst, |
| | commercially available from Momentive |
| | Performance Materials of Albany, NY as Niax ® |
| | A-537 |
| CATALYST C: | an acid blocked amine gelling catalyst, |
| | commercially available from Momentive |
| | Performance Materials of Albany, NY as Niax ® |
| | A-577 |
| CATALYST D: | an amine blowing catalyst, commercially |
| | available from Air Products and Chemicals of |
| | Allentown, PA as Polycat ® 33 |
| CATALYST E: | an acid blocked amine gelling catalyst, |
| | commercially available from Air Products and |
| | Chemicals of Allentown, PA as Dabco ® 1028 |
| ISOCYANATE A: | a modified polymeric methylene (diphenyl |
| | diisocyanate) having an NCO group content of |
| | about 30.4% by weight |
| PVC A: | particles of polyvinyl chloride, commercially |
| | available from Geon, Inc. of Akron, Ohio as |
| | GEON ® 121AR |
| FLAME | ammonium polyphosphate, commercially |
| RETARDANT A: | available from Clariant Corp. of Charlotte, NC, |
| | as Exolit ® AP-422 |
| FLAME | alumina trihydrate, commercially available from |
| RETARDANT B: | Huber Engineered Materials of Atlanta, GA, as |
| | Hubercarb ® SB 122 |
| FLAME | zinc borate, commercially available from U.S. |
| RETARDANT C: | Borax, Inc.of Valencia, CA, as Firebreak ® ZB |
| PIGMENT A: | Brown iron oxide pigment, commercially |
| | available from Ricon Color Inc. of West |
| | Chicago, IL as DPU-B2371-2B |

### Comparative Examples 1 and 2 and Examples 3, 4 and 5 of the Present Invention

Rigid foams were made by combining the components in the amounts as show in Table I. Shingles of varying dimensions and thicknesses were prepared in steel molds with a “cedar shake” profile. More specifically, 3 different size shingles were prepared from the formulation of each example. The shingles were 5″ wide by 24″ long, 7″ wide by 24″ long, and 12″ wide, by 24″ long. The thickness of the shingles varied from 0.19″ on the unexposed end to 0.50″ on the show surface. All parts were molded (at 140° F. mold temperature) at the same density (18 pcf) using the same conditions (105° F. isocyanate/110° F. filled polyol blend) on the same reaction injection molding machine.

TABLE I

| Formulation Details | Ex. C1 | Ex. C2 | Ex. 3 | Ex. 4 | Ex. 5 |
|---|---|---|---|---|---|
| POLYOL A | 48.10 | 48.25 | 48.25 | 48.25 | — |
| POLYOL B | 28.86 | 28.86 | 28.86 | 28.86 | 30.00 |
| POLYOL C | | — | — | — | 60.00 |
| POLYOL D | 19.24 | 19.24 | 19.24 | 19.24 | 6.50 |
| SURFACTANT A | 0.866 | 0.866 | 0.866 | 0.956 | — |
| SURFACTANT B | — | — | — | — | 0.950 |
| WATER | 0.962 | 0.900 | 0.900 | 0.232 | 0.800 |
| CATALYST A | 0.058 | 0.059 | 0.059 | 0.059 | — |
| CATALYST B | 0.962 | 0.912 | 0.912 | 0.912 | — |
| CATALYST C | 0.962 | 0.912 | 0.912 | 0.912 | 1.000 |
| CATALYST D | — | — | — | — | 0.250 |
| CATALYST E | — | — | — | — | 0.500 |
| ISOCYANATE A | 144.4 | 142.7 | 139.1 | 129.4 | 105.5 |
| FLAME RETARDANT | 21.79 | 27.53 | 27.53 | 20.75 | 18.55 |
| A | | | | | |
| FLAME RETARDANT | 50.93 | 64.33 | 53.60 | 20.75 | 18.55 |
| B | | | | | |
| FLAME RETARDANT | 6.71 | 8.475 | 19.20 | 20.75 | 18.55 |
| C | | | | | |
| PVC A | 6.71 | 8.475 | 8.475 | 0.296 | — |
| PIGMENT A | 4.795 | 6.043 | 6.043 | 5.009 | 3.789 |
| % Total Flame | 25.69 | 30.43 | 30.43 | 21.10 | 21.00 |
| Retardant¹ | | | | | |
| % Firebreak ZB² | 2.00 | 2.37 | 5.37 | 7.00 | 7.00 |
| Time for Flames to | 14.49 | 36.53 | 61.34 | >90 | >90 |
| appear on underside | | | | | |
| of plywood deck | | | | | |
| (minutes)³ | | | | | |
| Relative flexibility | 3 | 5 | 4 | 1 | 2 |
| (ranking 1 best, 5 worst) | | | | | |

¹Total flame retardant is based on entire weight of all ingredients and includes PVC A.
²Zinc borate concentration is based on entire weight of all ingredients.
³A description of the test protocol is included herein.

The comparative example systems (Examples C1 and C2) were formulated with the same polyol and isocyanate that were used in Examples 3 and 4, which fall within the claims of the present invention. The amounts of flame retardant and relative amount of zinc borate in the total polymer were varied.

The test panels were evaluated by the UL 790 (Underwriters Laboratories Standard) test protocol also known as ASTM E108. Test decks were constructed using this protocol with shingles made from the various rigid foam formulations. A layer of VersaShield (fire resistant roofing underlay sheeting available from Elk Building Products, a subsidiary of GAF Materials Corp., Wayne, N.J.) was applied directly to the plywood prior to attaching the shingles. A second layer (interplay) of VersaShield was applied on the section of shingle that would be covered by the next course of shingles for each layer.

The UL 790 tests for Fire Resistance of Roof Covering Materials is the principle standard employed in the evaluation of roofing materials. Testing to determine a roof covering's fire classification is conducted under ANSI/UL 790 and is intended to measure the roof covering material's fire-resistance characteristics against fire originating from outside a building or structure. The Class A Burning Brand test measures the roofing assemblies' resistance to flame penetration by an ignited object falling on the roof. A 3.5 ft. wide by 4.33 ft. long plywood test deck with the roof covering in place are set up with a pitch of 5 inches over a 12 inch span of roofing. Flaming grids of kiln-dried Douglas fir 12 in.×12 in×2.25 in. weighing 4.5 pounds are placed on the roof covering and a 12 mph air current is fanned from the bottom of the test deck for the duration of the test. The test can be concluded when the brand is consumed and all evidence of flame, glow, and smoke has disappeared from both the exposed surface of the roof covering and the underside (plywood) of the test deck or until failure occurs. Failure is defined as appearance of flame on the plywood surface. If no flame appears within 90 minutes, the material is given a Class A rating.

An examination of the first two Comparative Examples shows that the performance in this test does indeed increase simply by increasing the total amount of flame retardant in the polymer part. However, the increased amount of flame retardant decreases the impact resistance of the parts so that they are brittle and difficult to attach to a roof with normal installation procedures (e.g., with a nail and hammer). Examination of Comparative Example 2 with Example 3 shows the much improved performance of the panels by increasing the relative amount of zinc borate in them without increasing total flame retardant. Further improvement is noted in Example 4, wherein it is shown that by increasing the amount of zinc borate further, it is possible to reduce the overall amount of flame retardant and improve both fire-resistance and impact resistance of the panels.

Example 5 shows that this flame retardant composition is efficient enough to allow one to use more rigid aromatic ester based materials and maintain good impact properties.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

1. A fire-resistant, molded, medium density polyurethane foam comprising:
a) more than 75 to 85 parts by weight of a polyurethane foam forming reactive mixture, wherein said polyurethane foam forming reactive mixture comprises:
(1) one or more polymethylene poly(phenyl isocyanate, an isocyanate group containing prepolymer based on a polymethylene poly(phenyl isocyanate) or a mixture thereof;
and
(2) one or more isocyanate-reactive components comprising:
(a) at least one polyester polyol,
(b) at least one branched polyether polyol,
and
(c) at least one chain extender;
and
b) 15 to less than 25 parts by weight of solid flame retardant comprising
(i) ammonium polyphosphate,
(ii) zinc borate,
and, optionally,
(iii) one or more metal oxides or hydrates thereof,
in which the weight ratio of ammonium polyphosphate to zinc borate ranges from 3:1 to 1:3;
wherein the resultant polyurethane foam comprises at least 5% by weight, based on 100% by weight of the foam, of zinc borate.

2. (canceled)

3. The polyurethane foam of claim 1 which has a density of 10 to 30 pcf.

4. The polyurethane foam of claim 1, wherein b)(iii) said one or more metal oxides or hydrates thereof comprises alumina trihydrate, which is present in a weight ratio of zinc borate to alumina trihydrate of 1:3 to 3:1.

5. (canceled)

6. The polyurethane foam of claim 1, wherein
a) said polyurethane foam forming reactive mixture comprises
(1) one or more polymethylene poly(phenyl isocyanate, an isocyanate group containing prepolymer based on a polymethylene poly(phenyl isocyanate) or a mixture thereof;
and
(2) one or more isocyanate-reactive components comprising:
(a) at least one polyester polyol,
(b) at least one polyether polyol having a functionality of about 1.5 to 3 and an OH number of from about 14 to 56,
(c) at least one branched polyether polyol having a functionality of about 2.0 to 8.0 and an OH number of about 250 to 750,
and
(d) at least one chain extender.

7. The polyurethane foam of claim 1, wherein a polyisocyanate prepolymer comprising the reaction product of polymethylene poly(phenyl isocyanate) and a 450 molecular weight polyester, said prepolymer having an NCO group content of about 30.5%, a functionality of about 2.8, and a viscosity of about 350 mPa·s at 25° C. is present as the isocyanate component in the polyurethane foam forming reactive mixture.

8. The polyurethane foam of claim 1, additionally comprising one or more liquid flame retardants.

9. A process for preparing a fire-resistant, molded, medium density polyurethane foam comprising:
(1) introducing a polyurethane foam forming composition into an open mold,
(2) closing the mold,
(3) allowing the composition to react,
and
(4) removing the molded polyurethane foam from the mold,
wherein said polyurethane foam forming composition comprises:
a) more than 75 to 85 parts by weight of a polyurethane foam forming reactive mixture, said polyurethane foam forming reactive mixture comprising:
(1) one or more polymethylene poly(phenyl isocyanate, an isocyanate group containing prepolymer based on a polymethylene poly(phenyl isocyanate) or a mixture thereof;
and
(2) one or more isocyanate-reactive components comprising:
(a) at least one polyester polyol,
(b) at least one branched polyether polyol, and
(c) at least one chain extender;
and
b) 15 to less than 25 parts by weight of solid flame retardant comprising
(i) ammonium polyphosphate,
(ii) zinc borate,
and, optionally,
(iii) one or more metal oxides or hydrates thereof,
in which the weight ratio of ammonium polyphosphate to zinc borate ranges from 3:1 to 1:3;
and the resultant polyurethane foam comprises at least 5% by weight, based on 100% by weight of the foam, of zinc borate.

10. (canceled)

11. The process of claim 9 in which the resultant polyurethane foam has a density of 10 to 30 pcf.

12. The process of claim 9, wherein b)(iii) said one or more metal oxides or hydrates thereof comprises alumina trihydrate, which is present in a weight ratio of zinc borate to alumina trihydrate of 1:3 to 3:1.

13. (canceled)

14. The process of claim 9, wherein a) said polyurethane foam forming reactive mixture comprises
(1) one or more polymethylene poly(phenyl isocyanate, an isocyanate group containing prepolymer based on a polymethylene poly(phenyl isocyanate) or a mixture thereof;
and
(2) one or more isocyanate-reactive components comprising:
(a) at least one polyester polyol,
(b) at least one polyether polyol having a functionality of about 1.5 to 3 and an OH number of from about 14 to 56,
(c) at least one branched polyether polyol having a functionality of about 2.0 to 8.0 and an OH number of about 250 to 750,
and
(e) at least one chain extender.

15. The process of claim 9, wherein a polyisocyanate prepolymer comprising the reaction product of polymethylene poly(phenyl isocyanate) and a 450 molecular weight polyester, said prepolymer having an NCO group content of about 30.5%, a functionality of about 2.8, and a viscosity of about 350 mPa·s at 25° C. is present as the isocyanate component in the polyurethane foam forming reactive mixture.

16. The process of claim 9, in which the polyurethane foam forming reactive mixture additionally comprises one or more liquid flame retardants.
